(19) United States
(12) Patent Application Publication
(10) Pub. No.: US 2026/0266127 A1
(43) Pub. Date: Sep. 10, 2026

(54) SECTIONAL DOOR WITH CABLE CARRIER FOR POWER CABLE

(71) Applicant: CornellCookson, LLC, Mountain Top, PA (US)

(72) Inventors: Andrey Vasiliyevich Melguy, Tempe, AZ (US); Robert Davis Sparks, Phoenix, AZ (US)

(73) Assignee: CornellCookson, LLC, Mountain Top, PA (US)

(21) Appl. No.: 19/165,258

(22) PCT Filed: Mar. 21, 2023
(86) PCT No.: PCT/US2023/015829

§ 371 Date: Sep. 15, 2025

(51) Int. Cl. E06B 7/28; E06B 3/70

(52) U.S. Cl. CPC E06B 7/28; E06B 3/7003; E06B 2003/7044

(57) ABSTRACT

In example implementations, a cable carrier assembly for a sectional door is provided. The cable carrier assembly includes a cable carrier track coupled to a track of the sectional door, a sectional cable carrier guide coupled to a panel of the sectional door, and a cable carrier, wherein a first end of the cable carrier is coupled to the cable carrier track and a second end of the cable carrier is coupled to the sectional cable carrier guide.

### BACKGROUND

Doors can be used for a variety of applications. For example, doors can be used as in residential locations or doors for bays and entrances to warehouses in commercial locations. Some doors may include sectional doors. One type of sectional door may be garage doors.

Sectional doors may be made from a plurality of individual sections that are mechanically coupled together. The size and number of sections may be determined based on a size of the opening of the garage or any other type of location with an opening. Each section may have a wheel that can fit into a track. The track may guide movement of each section of the sectional door while opening and closing. The sectional door can be opened and closed manually with the help of a loaded torsion spring or mechanically via a motor or garage door opener.

### BRIEF DESCRIPTION OF THE DRAWINGS

FIG. 1 illustrates a block diagram of an example sectional door with the cable carrier of the present disclosure;

FIG. 2 illustrates a close up view of an example of a cable carrier track, the cable carrier, and a sectional cable carrier guide on a top section of the sectional door of the present disclosure;

FIG. 3 illustrates a cross-sectional view of an example cable carrier track of the present disclosure;

FIG. 4 illustrates a top back isometric view of an example of the sectional cable carrier guide of the present disclosure;

FIG. 5 illustrates a top front isometric view of an example of the sectional cable carrier guide of the present disclosure;

FIG. 6 illustrates a bottom front isometric view of an example of the sectional cable carrier guide of the present disclosure;

FIG. 7 illustrates a cut-away view of an example of the sectional cable carrier guide of the present disclosure and how the power cable is fed into the top panel of the sectional door;

FIG. 8 illustrates another example of the cable carrier track of the present disclosure; and

FIG. 9 illustrates an example of a cable carrier of the present disclosure.

### DETAILED DESCRIPTION

Examples described herein provide examples of a sectional door with a cable carrier for power cables. As discussed above, doors can be used for a variety of different applications. Some doors may be sectional doors, such as those used as garage doors.

Some sectional doors may include panels with an electronic component. Providing continuous power to the panels can be difficult as the sectional door may move along a track. The movement of the sectional door and the various components of the track may make it difficult to wire the sectional door for power. The wire may become tangled or stuck along the various components of the sectional door and/or track.

The present disclosure provides a cable carrier design that allows wiring for continuous power to sectional door. The cable carrier design of the present disclosure can provide continuous power without impeding operation of the sectional door. For example, the cable carrier design of the present disclosure avoids getting tangled or caught in the sectional door and/or track of the sectional door.

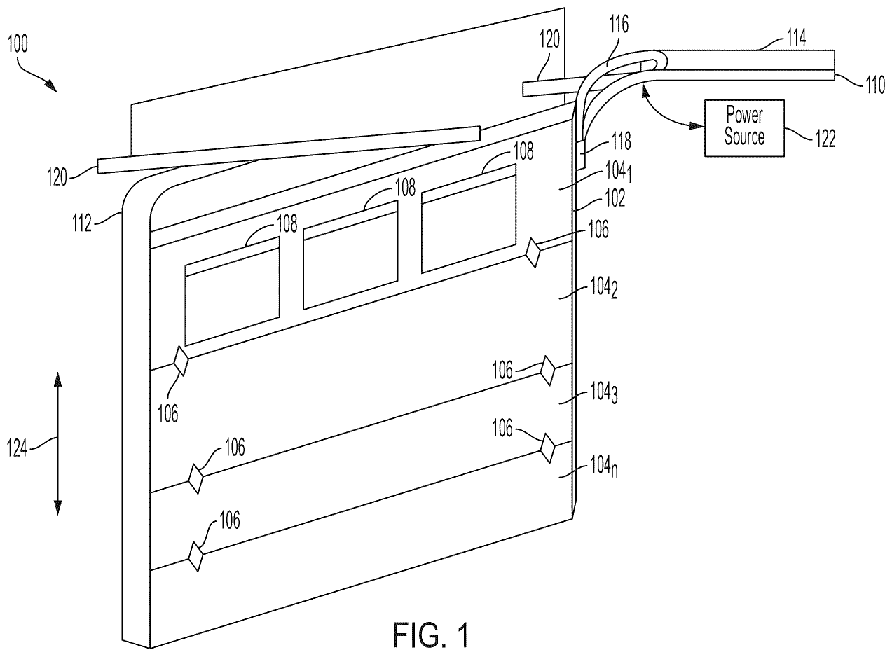

FIG. 1 illustrates a block diagram of a sectional door assembly 100 of the present disclosure. It should be noted that the sectional door assembly 100 in FIG. 1 has been simplified for ease of explanation. The sectional door assembly 100 may include additional features that are not shown. For example the sectional door 100 may include a rotating shaft, torsion springs, an operator, a user interface to control operation of the sectional door, one or more sensors, and the like.

In one embodiment, the sectional door assembly 100 may include a sectional door 102 that comprises a plurality of panels or sections 104₁ to 104ₙ (hereinafter also referred to individually as a panel 104 or collectively as panels 104). The panels may be movably connected to one another via mechanical hinges 106. One or more hinges 106 may be coupled to adjacent panels 104. The first panel 104₁ may be the top most panel 104 and the last panel 104ₙ may be the bottom most panel 104.

In one embodiment, some of the panels 104 may include an electronic component 108 that requires continuous power. As noted above, delivering continuous power to an electronic component 108 within a panel 104 may be difficult. For example, traditional wiring directly to the panel may become tangled or interfere with proper operation of the sectional door 102.

The sectional door 102 may be guided by tracks 110 and 112. The tracks 110 and 112 may be installed on opposite sides of the sectional door 102. A wheel (not shown) may be inserted into the tracks 110 and 112. In the case of a garage door, the garage door may have wheels that move within the tracks 110 and 112 as the garage door opens and closes in a direction as shown by an arrow 124.

The tracks 110 and 112 may be coupled to a wall of an opening where the sectional door 102 is installed. Horizontal angle brackets 120 may be coupled to a flag bracket (not shown) that is attached to the wall may further help to stabilize the tracks 110 and 112.

In one embodiment, the sectional door 102 may include a cable carrier assembly. The cable carrier assembly may include a cable carrier track 114, a cable carrier 116, and sectional cable carrier guide 118. The cable carrier assembly may provide a way to provide power to the electronic component 108 of a panel 104 of the sectional door 102. For example, wiring or a power cable may connect a power source 122 to the panel 104. The wiring may be fed through the cable carrier 116 and the sectional cable carrier guide 118 into an opening in the panel 104. While the phrase “cable carrier” is used herein, the specific structure known as a cable carrier or cable carrier assembly may also be a conduit structure of any type that provides a containment structure for the wiring that is capable of moving within the cable carrier track 114.

The cable carrier assembly may be designed such that the electrical wiring or power cable does not interfere with operation of the sectional door 102. In other words, the cable carrier assembly may prevent the electrical wiring from getting tangled or caught in the track 110 or track 112 while the section door 102 is opening and closing.

The cable carrier 116 may be selected to provide appropriate durability. Suitable materials may include, nylon, steel, or aluminum. The structure of the cable carrier 116 may be selected to provide movement through multiple planes of movement such as that traveled by the sectional door 102 within the track 110 or track 112, such as a reverse bending radius cable carrier. Dampening elements may be added to reduce the noise of the cable carrier 116. Magnetic features may allow the cable carrier 116 to follow the interior surface of the cable carrier track 114, discussed further below.

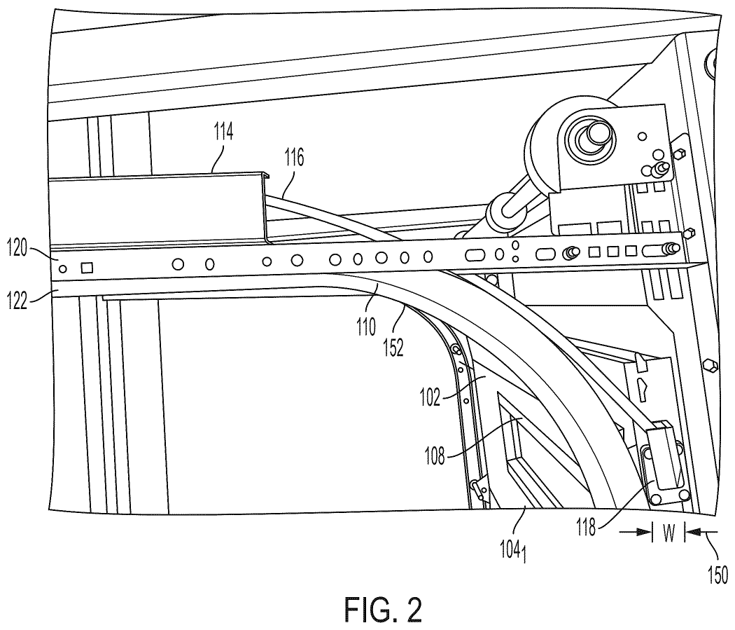

FIG. 2 illustrates a close up view of an example of the cable carrier track 114, the cable carrier 116, and the sectional cable carrier guide 118. FIG. 2 illustrates how the cable carrier track 114, the cable carrier 116, and the sectional cable carrier guide 118 may be arranged on the sectional door assembly 100.

In one embodiment, the cable carrier track 114 may be coupled to one of the tracks 110 or 112. In the example illustrated in FIG. 2, the cable carrier track 114 is coupled to the track 110. However, it should be noted that the cable carrier track 114 may also be coupled to the track 112.

The cable carrier track 114 may be coupled to a horizontal portion 122 of the track 110. The horizontal portion 122 may be a portion of the track 110 that is parallel to the floor or ground and is located on a highest point of the track 110.

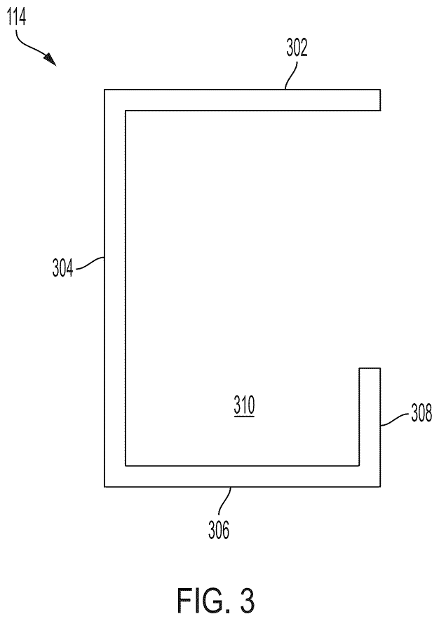

FIG. 3 illustrates a cross-sectional view of an example of the cable carrier track 114. The cable carrier track 114 may be fabricated from steel or metal. The cable carrier track 114 may be formed as separate components that are coupled together or may be fabricated, formed and/or molded by a single piece of metal or steel.

In one embodiment, the cable carrier track 114 may include a first horizontal member 302, a vertical member 304, a second horizontal member 306, and a lip 308. The first horizontal member 302 and the second horizontal member 306 may be parallel. The vertical member 304 and the lip 308 may be parallel. The first horizontal member 302 and the second horizontal member 306 may be normal or perpendicular to the vertical member 304 and the lip 308. The first horizontal member 302, the vertical member 304, the second horizontal member 306, and the lip 308 may form an inner volume 310. The cable carrier 116 may be located inside of the inner volume 310.

In one embodiment, the vertical member 304, the second horizontal member 306, and the lip 308 may form a “J” shaped enclosure. The cross-sectional “J” shape of the cable carrier track 114 may prevent kinks from forming in the cable carrier 116 as the cable carrier 116 moves back and forth within the cable carrier track 114. The first horizontal member 302 and the second horizontal member 306 may help guide movement of the cable carrier 116 within the cable carrier track 114 as the sectional door 102 opens and closes. In an optional embodiment, an inner surface of the cable carrier track 114 may comprise a texture or structure to interlock with the cable carrier 116 sections. The cable carrier 116 may then travel in a desired and repeatable way and may further provide quiet operation when traveling within the cable carrier track 114.

Referring back to FIG. 2, a first end of the cable carrier 116 may be coupled to the cable carrier track 114. For example, the first end of the cable carrier 116 may be coupled to the second horizontal member 306 (shown in FIG. 3) of the cable carrier track 114.

A second end of the cable carrier 116 may be coupled to the sectional cable carrier guide 118. FIG. 2 illustrates the sectional cable carrier guide 118 being coupled to the top most panel 104₁. Although, the sectional cable carrier guide 118 may be coupled to any panel 104 of the sectional door 102, it may be beneficial to couple the sectional cable carrier guide 118 to the top most panel 104₁. Placing the sectional cable carrier guide 118 to the top most panel 104₁ may protect the electrical wiring or power cable from interference or obstructions during normal operation where items may be placed to the left or right of the door opening that could fall into the cable carrier track 114.

The sectional cable carrier guide 118 provides a transition for the electrical wires to the electronic component 108 of a panel 104 of the sectional door 102 and a detachable connection point for the second end of the cable carrier 116. The sectional cable carrier guide 118 may be integral with the panel 104 or a component of the panel 104. In one embodiment, the sectional cable carrier guide 118 may be a component of the end stile of the panel 104. The end stile may comprise a channel structure to engage the panel structure (and thereby providing a surface for mounting roller hinges, bottom brackets, top brackets or struts) and a transition structure extending from the end stile surface that allows for the connection of the end of the sectional cable carrier guide 118 and for electrical wires to transition from sectional cable carrier guide 118 through the end stile and into the panel 104. In an embodiment, the sectional cable carrier guide 118 may be a separate structure that is mounted to the panel 104 or a component of the panel 104, such as the end stile.

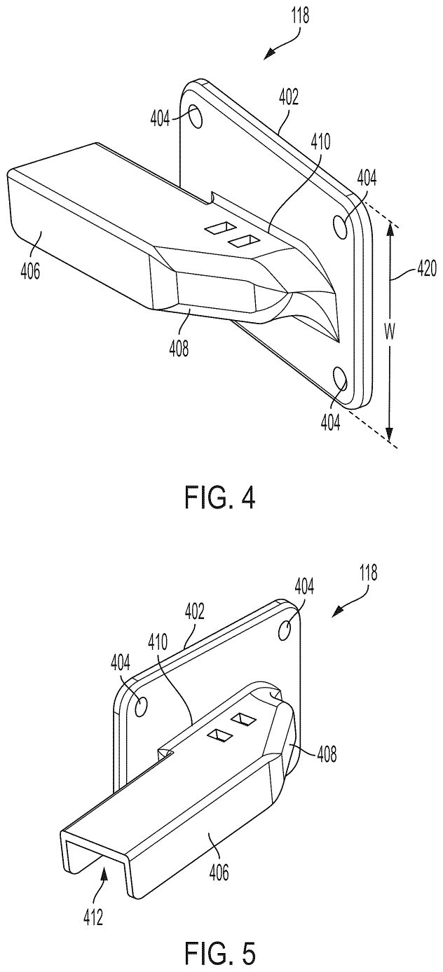

FIGS. 4-6 illustrate various views of an example of the sectional cable carrier guide 118. FIG. 4 illustrates a top back isometric view of an example of the sectional cable carrier guide 118. The sectional cable carrier guide 118 may include a base plate 402 that includes a plurality of openings 404. The base plate 402 may be placed adjacent or on a side of the panel 104 of the sectional door 102. The openings 404 may be aligned with corresponding openings on the panel 104. A mechanical fastener (not shown) may be used to then couple the sectional cable carrier guide 118 to the side of the panel 104. The mechanical fastener may be a threaded screw, a nail, a nut and bolt, and the like.

A width 420 of the base plate 402 may be less than a width 150 of the panel 104 (shown in FIG. 2). Thus, the dimensions of the sectional cable carrier guide 118 may not interfere with proper operation of the sectional door 102.

In one embodiment, the sectional cable carrier guide 118 may include a vertical portion 406, an angled portion 408, and a horizontal portion 410. The vertical portion 406, the angled portion 408, the horizontal portion 410, and the base plate 402 may be separate components that are coupled or glued together or may be a single continuous component that is molded or fabricated from a single piece of material.

The angled portion 408 may connect the vertical portion 406 to the horizontal portion 410 and have a surface that is approximately 45 degrees relative to both the vertical portion 406 and the horizontal portion 410. The horizontal portion 410 may be connected to the base plate 402.

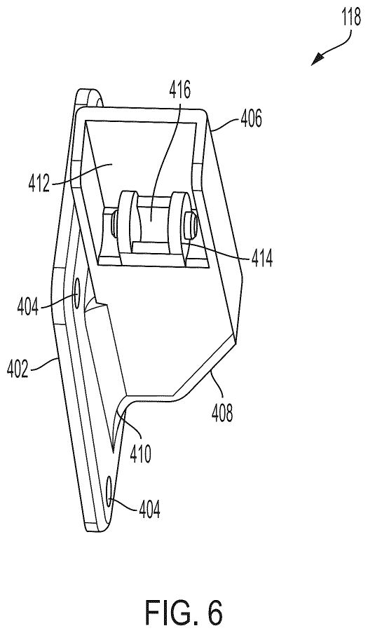

FIG. 5 illustrates a top front isometric view of an example of the sectional cable carrier guide 118. FIG. 5 illustrates a front of the vertical portion 406. The vertical portion 406 may include an opening 412. The opening 412 may have a “C” cross-sectional shape that is formed by three sides. The second end of the cable carrier 116 may be inserted into the opening 412 to be coupled to the sectional cable carrier guide 118.

FIG. 6 illustrates a bottom front isometric view of the sectional cable carrier guide 118. FIG. 6 illustrates a cable carrier connection member 414 located inside of the opening 412. The cable carrier connection member 414 may include a shape and design to mechanically connect to the second end of the cable carrier 116.

In the example illustrated in FIG. 6, the cable carrier connection member 414 may include opposing arms with protruding tabs. The second end of the cable carrier 116 may include opposing arms with openings that correspond to the protruding tabs. The opposing arms of the second end of the cable carrier 116 may be mated with the opposing arms of the cable carrier connection member 414 such that the protruding tabs fit into the openings on the opposing arms of the second end of the cable carrier 116. However, other mechanical connections may also be used such as interlocking tabs, interference fits, and the like.

In one embodiment, the cable carrier connection member 414 may include an opening 416. The opening 416 may be located in a center of the cable carrier connection member 414. The opening 416 may allow an electric wire to be passed through the vertical portion 406, through the angled portion 408, the horizontal portion 410, and into the panel 104, for example through the end stile.

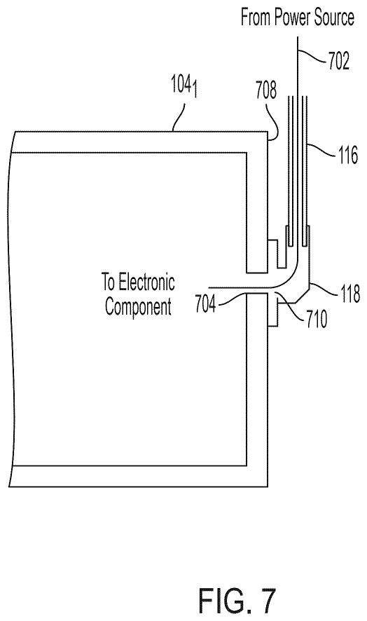

FIG. 7 illustrates a cut-away view of an example of the sectional cable carrier guide 118 and how a power cable 702 is fed into a top most panel 104₁. In one embodiment, the top most panel 104₁ may include an opening 704 located on a side 708 of the top most panel 104₁. The side 708 may be an edge of the panel 104₁ that is located adjacent to the track 110.

The sectional cable carrier guide 118 may be coupled to the side 708 such that an opening 710 aligns with the opening 704 in the side 708 of the panel 104₁. The openings 404 of the base plate 402 may also be aligned with corresponding openings (not shown) in the side 708 of the panel 104₁ such as an opening in the end stile.

FIG. 7 illustrates how the cable carrier 116 is connected to the sectional cable carrier guide 118 inside of the opening 412 of the vertical portion 406 of the sectional cable carrier guide 118. The power cable 702 is connected to the power source 122 and fed through the cable carrier 116, through the sectional cable carrier guide 118, through the opening 710 and into the top most panel 104₁ through the opening 704. The power cable 702 may then be connected to an electronic component 108 in the top most panel 104₁ or connected to an electric component 108 located in another panel to which the sectional cable carrier guide 118 is connected.

Referring back to FIG. 2, FIG. 2 illustrates how the cable carrier 116 is connected to the cable carrier track 114 and the sectional cable carrier guide 118. The cable carrier 116 may be positioned to be above a curved portion 152 of the track 110. It should be noted that the position of the cable carrier 116 should be such that the cable carrier 116 is not too high or too low. If the cable carrier 116 is too high, the cable carrier 116 may kink during operation of the sectional door 102. If the cable carrier 116 is too low, the cable carrier 116 may contact the track 110 interfering with proper operation of the sectional door 102. For example, the cable carrier 116 should be positioned such that a middle of the cable carrier 116 is a few centimeters (e.g., 2-10 cm) away from a midpoint of the curved portion 152 of the track 110.

The cable carrier 116 may also be connected such that cable carrier 116 is slightly curved. For example, a portion of the cable carrier 116 may have a curve that follows a curve of a curved portion 152 of the track 110.

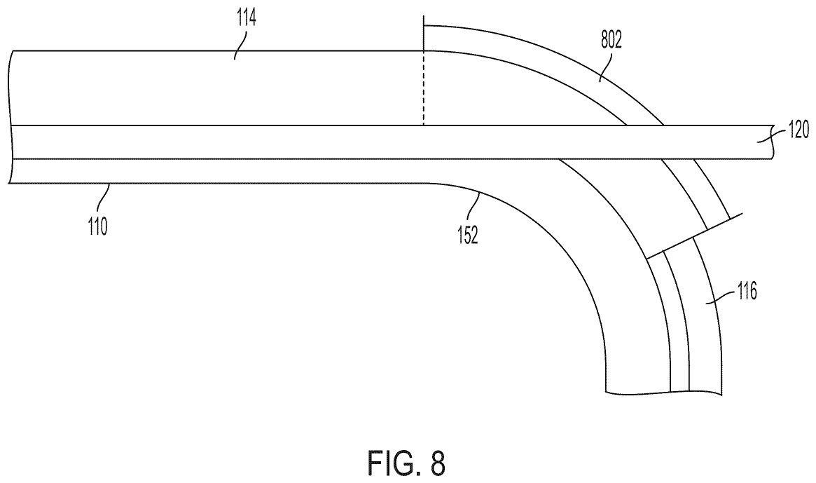

In one embodiment, the cable carrier track 114 may be modified to include a curved portion. FIG. 8 illustrates an example of the cable carrier track 114 with a curved portion 802. For example, the cable carrier track 114 may be extended to include the curved portion 802. The curved portion 802 may have a curvature that matches the curvature of the curved portion 152 of the track 110. The curved portion 802 of the cable carrier track 114 may further guide the movement of the cable carrier 116. The curved portion 802 may also prevent kinks from forming in the cable carrier 116 as the cable carrier 116 moves along with the movement of the sectional door 102.

In one embodiment, the cable carrier track 114 is connected to the tracks 110 or 112 that are vertically located on each side of the door sections. The sectional cable carrier guide 118 may be located on the bottom most panel 104ₙ.

In one embodiment, the cable carrier track 114 is connected to a garage door opener rail. The cable carrier track 114 should be mounted so as to not interfere with the operation of the chain, cable, or belt of the opener trolley.

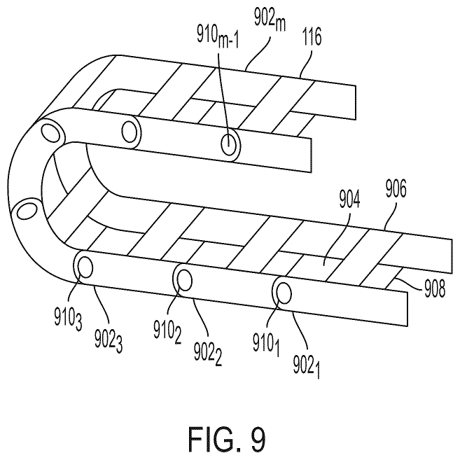

FIG. 9 illustrates an example of the cable carrier 116. The cable carrier 116 may be fabricated from metal or plastic. The cable carrier 116 may include sections 902₁ to 902ₘ (hereinafter also referred to individually as a section 902 or collectively as sections 902) that are movably coupled together. Each section 902 may be connected via rotating couplings 910₁ to 910ₘ₋₁ (hereinafter also referred to individually as a rotating coupling 910 or collectively as rotating couplings 910).

Each section 902 may include a bottom surface 904 and a top surface 906. Each end of each section 902 may include an interior volume 908. The power cable 702 may be fed through the interior volume 908 and pass through each section 902 of the cable carrier 116. The bottom surface 904 and the top surface 906 may support the power cable 702 within the cable carrier 116. The interior volume 908, comprising a height and a width, should be at least 10% larger than the diameter of the power cable 702.

It should be noted that FIG. 9 illustrates one example of a cable carrier 116. However, it should be noted that any type of cable carrier that can contain the power cable 702 may be used in the cable carrier assembly. Moreover, the dimensions of the cable carrier 116 (e.g., length, width, and height) may be a function of a size of the sectional door 102. For example, larger sectional doors 102 may have a cable carrier 116 with a larger length, width, and height. Smaller sectional doors may have a cable carrier 116 with a smaller length, width, and height.

Thus, the present disclosure provides a cable carrier assembly for sectional doors that allows power cables or electrical wiring to be properly connected to one or more panels of the sectional door. The cable carrier assembly may prevent power cables or electrical wiring to the panels of the sectional door from interfering with the operation of the sectional door. As a result, sectional doors may have continuous power delivered to electronic components within the panel that may require continuous power.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A cable carrier assembly for a sectional door, comprising:
a cable carrier track;
a sectional cable carrier guide coupled to a panel of the sectional door; and
a cable carrier, wherein a first end of the cable carrier is coupled to the cable carrier track and a second end of the cable carrier is coupled to the sectional cable carrier guide.

2. The cable carrier assembly of claim 1, wherein the cable carrier track is coupled to a horizontal section of a track of the sectional door.

3. The cable carrier assembly of claim 2, wherein the cable carrier track comprises a curved portion that matches a curve of the track.

4. The cable carrier assembly of claim 1, wherein the cable carrier track comprises a lip member to contain the cable carrier within a volume of the cable carrier track.

5. The cable carrier assembly of claim 1, wherein the panel comprises a top most panel of the sectional door.

6. The cable carrier assembly of claim 1, wherein the sectional cable carrier guide comprises a vertical portion, an angled portion, and a horizontal portion.

7. The cable carrier assembly of claim 6, wherein the vertical portion comprises:
a cable carrier connection member to mechanically connect to the second end of the cable carrier.

8. The cable carrier assembly of claim 7, wherein the cable carrier connection member comprises an opening to feed a wire through the angled portion and the horizontal portion into an opening of the panel of the sectional door.

9. A cable carrier assembly for a sectional door, comprising:
a cable carrier track coupled to a track of the sectional door;
a sectional cable carrier guide coupled to a panel of the sectional door;
a cable carrier, wherein a first end of the cable carrier is coupled to the cable carrier track and a second end of the cable carrier is coupled to the sectional cable carrier guide; and
an electrical wire connected to a power source and an electronic component within the panel, wherein the electrical wire is fed through the cable carrier and the sectional cable carrier guide into the panel.

10. The cable carrier assembly of claim 9, wherein the cable carrier track is coupled to a horizontal section of the track.

11. The cable carrier assembly of claim 10, wherein the cable carrier track comprises a curved portion that matches a curve of the track.

12. The cable carrier assembly of claim 9, wherein the cable carrier track comprises a lip member to contain the cable carrier within a volume of the cable carrier track.

13. The cable carrier assembly of claim 9, wherein the panel comprises a top most panel of the sectional door.

14. The cable carrier assembly of claim 9, wherein the sectional cable carrier guide comprises a vertical portion, an angled portion, and a horizontal portion.

15. The cable carrier assembly of claim 14, wherein the vertical portion comprises:
a cable carrier connection member to mechanically connect to the second end of the cable carrier.

16. The cable carrier assembly of claim 15, wherein the cable carrier connection member comprises an opening, wherein the electrical wire is fed through the angled portion and the horizontal portion via the opening and into an opening of the panel of the sectional door.

17. A sectional door assembly, comprising:
a first track and a second track;
a sectional door comprising a plurality of panels, wherein the sectional door is movably coupled into the first track and the second track, wherein the first track and the second track guide a movement of the sectional door; and
a cable carrier assembly coupled to at least the first track or the second track to feed an electrical wire to an electronic component in a panel of the plurality of panels of the sectional door.

18. The sectional door assembly of claim 17, wherein the cable carrier assembly, comprises:
a cable carrier track coupled to at least the first track or the second track;
a sectional cable carrier guide coupled to a top most panel of the plurality of panels; and
a cable carrier, wherein a first end of the cable carrier is coupled to the cable carrier track and a second end of the cable carrier is coupled to the sectional cable carrier guide.

19. The sectional door of claim 18, wherein the cable carrier track is coupled to a horizontal section of at least the first track or the second track.

20. The sectional door of claim 18, wherein the cable carrier track comprises a lip member to contain the cable carrier within a volume of the cable carrier track.
